(19) United States
(12) Patent Application Publication
(10) Pub. No.: US 2026/0341602 A1
(43) Pub. Date: Oct. 29, 2026

(54) CAPACITOR

(71) Applicant: Panasonic Intellectual Property Management Co., Ltd., Osaka (JP)

(72) Inventors: Takashi SASAKI, OSAKA FU (JP); Fumiya KAMBAYASHI, OSAKA FU (JP); Shinji TAKEOKA, OSAKA FU (JP)

(21) Appl. No.: 19/111,647

(22) PCT Filed: Sep. 1, 2023
(86) PCT No.: PCT/JP2023/032157

§ 371 Date: Mar. 13, 2025

(30) Foreign Application Priority Data
Sep. 30, 2022 (JP) 2022-159065

(51) Int. Cl. H01G 9/07; H01G 9/15

(52) U.S. Cl. CPC H01G 9/07; H01G 9/15

(57) ABSTRACT

A capacitor includes an anode, a stacked film, and a cathode that are stacked in the stated order. The stacked film includes at least two insulator layers and at least one semiconductor layer. The insulator layers and the semiconductor layer are alternately stacked. The insulator layers include a first insulator layer in contact with the anode and a second insulator layer in contact with the cathode. The thickness of the first insulator layer is smaller than the thickness of the second insulator layer.

### TECHNICAL FIELD

The present disclosure relates to capacitors, and more particularly, to a capacitor including two electrodes and an insulator between the two electrodes.

### BACKGROUND ART

Non-Patent Literature 1 discloses a stacked stricture including two electrodes and a stacked film between the two electrodes in which layers made of HfO₂ and layers made of ZnO are alternately stacked.

### Citation List

### [Non-Patent Literature]

Non-Patent Document 1: Qiannan Zhang et al. “Semiconducting ZnO effect on Maxwell-Wagner relaxation in HfO₂/ZnO nanolaminates fabricated by atomic layer deposition” Journal of Physics D: Applied Physics. 47 505302 (2014)

### SUMMARY OF INVENTION

A capacitor according to an aspect of the present disclosure includes an anode, a stacked film, and a cathode that are stacked in a stated order. The stacked film includes at least two insulator layers and at least one semiconductor layer, the insulator layers and the semiconductor layer being alternately stacked. The insulator layers include a first insulator layer in contact with the anode, and a second insulator layer in contact with the cathode. A thickness of the first insulator layer is smaller than a thickness of the second insulator layer.

According to the present disclosure, a capacitor with a stacked film, in which insulator layers and a semiconductor layer are stacked, can be provided with increased capacitance.

### BRIEF DESCRIPTION OF DRAWINGS

FIG. 1A is a schematic cross-sectional view of an example of a capacitor according to an embodiment of the present disclosure, and FIG. 1B is a schematic cross-sectional view of an example of a capacitor according to another embodiment of the present disclosure.

FIG. 2A is a schematic cross-sectional view of a step of a capacitor production method according to an embodiment of the present disclosure, and FIG. 2B is a schematic cross-sectional view of a step of the capacitor production method following the production method in FIG. 2A.

FIG. 3A is a schematic cross-sectional view of a step of the capacitor production method according to the embodiment of the present disclosure; FIG. 3B is a schematic cross-sectional view of a step of the capacitor production method following the capacitor production method in FIG. 3A; FIG. 3C is a schematic cross-sectional view of a step of the capacitor production method following the capacitor production method in FIG. 3B; and FIG. 3D is a schematic cross-sectional view of a step of the capacitor production method following the capacitor production method in FIG. 3C.

FIG. 4 is a schematic cross-sectional view of a step of the capacitor production method according to the embodiment of the present disclosure.

FIG. 5 is a schematic cross-sectional view of a step of the capacitor production method according to the embodiment of the present disclosure.

FIG. 6A is a schematic cross-sectional view of an evaluation circuit including a capacitor according to an embodiment of the present disclosure, and FIG. 6B is a schematic cross-sectional view of an evaluation circuit including a capacitor according to another embodiment of the present disclosure.

FIG. 7A is a schematic cross-sectional view of a capacitor according to a variation of the present disclosure, and FIG. 7B is a schematic cross-sectional view of a stacked film included in the capacitor according to the variation of the present disclosure.

FIG. 8 is a graph representation showing relationships between measurement frequency and capacitance of capacitors according to an embodiment of the present disclosure.

FIG. 9 is a graph representation showing relationships between measurement frequency and capacitance of capacitors according to another embodiment of the present disclosure.

FIG. 10 is a graph representation showing relationships between measurement frequency and capacitance of capacitors according to another embodiment of the present disclosure.

### DESCRIPTION OF EMBODIMENT

The present disclosure has its object of providing a capacitor including a stacked film of an insulator layer and a semiconductor layer with increased capacitance.

### (1) Embodiment

### (1.1) Outline

The process to arrive at a capacitor 1 of the present disclosure will be described.

Non-Patent Literature 1 discloses a stacked structure including two electrodes and a stacked film between the two electrodes in which insulator layers made of HfO₂ and semiconductor layers made of ZnO are alternately stacked. In this stacked structure, the capacitance is increased by increasing the total number of stacked films of the insulator layers and the semiconductor layers in the stacked film. When an attempt is made to further increase the capacitance of such a stacked structure, it is necessary to increase the total number of stacked films of the insulator layers and the semiconductor layers in the stacked film, which is not preferable from the point of view of productivity.

In view of the foregoing, the present inventor has conducted intensive studies in order to increase the capacitance of a stacked structure including a stacked film in which insulator layers and semiconductor layers are stacked, which has resulted in achievement of the present disclosure.

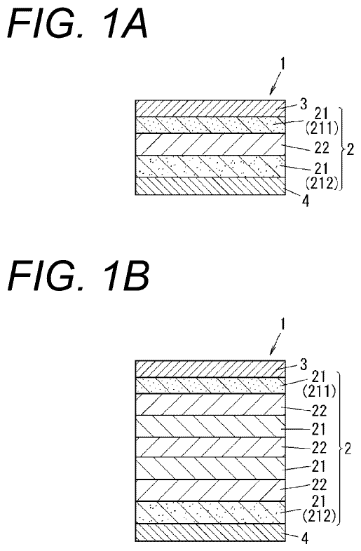

An embodiment and a variation will be described with reference to FIG. 1A to 10. Note that the following embodiment and variation are only some of various embodiments of the present disclosure. The following embodiment and variation can be variously altered, for example, according to the design as long as the object of the present disclosure can be achieved. It is also possible to combine the configuration of the variation as appropriate.

The drawings referred to below are schematic views, and the dimensional ratios of the elements of configuration in the drawings do not necessarily reflect actual dimensional ratios.

First, an overview of a capacitor 1 will be described with reference to FIGS. 1A and 1B. As illustrated in FIG. 1A, the capacitor 1 includes an anode 3 and a cathode 4 as electrodes and includes a stacked film 2 between the anode 3 and the cathode 4. That is, the capacitor 1 includes an anode 3, a stacked film 2, and a cathode 4 that are stacked in the stated order.

As illustrated in FIGS. 1A and 1B, the stacked film 2 includes at least two insulator layers 21 and at least one semiconductor layer 22, and the insulator layers 21 and the semiconductor layer 22 are alternately stacked. In other words, in the stacked film 2, the semiconductor layer 22 is located between the two insulator layers 21 and 21, and the outermost layers of the stacked film 2 are the insulator layers 21. The anode 3 and the cathode 4 are in contact with respective different insulator layers 21. In the present disclosure, the insulator layer 21 in contact with the anode 3 is referred to a first insulator layer 211, and the insulator layer 21 in contact with the cathode 4 is referred to as a second insulator layer 212. That is, the insulator layers 21 include a first insulator layer 211 in contact with the anode 3 and a second insulator layer 212 in contact with the cathode 4.

With respect to the first insulator layer 211 and the second insulator layer 212 located on the outermost sides of the stacked film 2, the thickness of the first insulator layer 211 is smaller than the thickness of the second insulator layer 212. This may increase the capacitance of the capacitor 1.

In one example, the capacitor 1 is used to eliminate an AC component (voltage noise) superimposed on a DC power supply. Voltage noise can be eliminated by installing the capacitor 1 (commonly referred to as a bypass capacitor) between the DC power supply and the ground (e.g., earth). The capacitor 1 can efficiently eliminate voltage noise as its capacitance increases within the desired frequency band. Application of the capacitor 1 is not limited to only the bypass capacitor. The capacitor 1 may be applied in a variety of applications.

### (1.2) Details

The capacitor 1 will be described in detail.

### (Anode and Cathode)

As described above, the capacitor 1 includes an anode 3 and a cathode 4 as electrodes. That is, when the capacitor 1 is installed in a circuit, the anode 3 of the capacitor 1 is electrically connected to a positive electrode of a power supply, and the cathode 4 is used so as to be electrically connected to a negative electrode of the power supply or the ground. In the present embodiment, the two electrodes included in the capacitor 1 are distinguished so that it is possible to determine which is the anode 3 and which is the cathode 4. There is no particular limitation on the method of distinguishing between the anode 3 and the cathode 4. For example, the anode 3 and the cathode 4 are distinguished from each other by marking the capacitor 1 to distinguish between the anode 3 and the cathode 4, making the shape of the anode 3 different from the shape of the cathode 4, or defining the positional relationship between the anode 3 and the cathode 4 in the capacitor 1.

As described above, the insulator layers 21 include a first insulator layer 211 in contact with the anode 3 and a second insulator layer 212 in contact with the cathode 4, and the thickness of the first insulator layer 211 is smaller than the thickness of the second insulator layer 212. In other words, of the two insulator layers 21 and 21 located on the outermost sides of the stacked film 2, the electrode in contact with the thinner insulator layer 21 can be used as the anode 3, and the electrode in contact with the thicker insulator layer 21 located on the opposite side thereto can be used as the cathode 4.

At least one of the anode 3 and the cathode 4 contains at least one selected from the group consisting of, for example, titanium (Ti), platinum (Pt), aluminum (Al), nickel (Ni), titanium nitride (TiN), tantalum (Ta), tantalum nitride (TaN), and gold (Au). Preferably, at least one of the anode 3 and the cathode 4 contains at least one of Ti, Pt and Al. In this case, the capacitance of the capacitor 1 may be increased.

In the capacitor 1, the thickness of the anode 3 is 0.01 μm or more and 1 mm or less, for example, and the thickness of the cathode 4 is 0.01 μm or more and 1 mm or less, for example.

Each of the anode 3 and the cathode 4 can be produced using an electron beam deposition method, for example. In this case, the thickness of each of the anode 3 and the cathode 4 produced using the electron beam vapor deposition method is easily adjusted. The anode 3 and the cathode 4 may be metal foils, for example. The surfaces of the metal foils may be roughened. This can increase the surface areas of the metal foils and also increase the area of the stacked film 2 in contact with the metal foils. The roughening method is not particularly limited, and an etching method can be employed, for example.

Further, each of the anode 3 and the cathode 4 may be a porous body. In other words, the metal contained in each of the anode 3 and the cathode 4 may be a porous metal, for example. In this case, the capacitance of the capacitor 1 may be increased.

The cathode 4 may contain a conductive polymer, for example. The conductive polymer contained in the cathode 4 includes at least one component selected from the group consisting of, for example, polypyrrole, polythiophene, polyaniline, and derivatives of these.

### (Stacked Film)

As described above, the capacitor 1 includes a stacked film 2. The stacked film 2 includes at least two insulator layers 21 and at least one semiconductor layer 22, and the insulator layers 21 and the semiconductor layer 22 are alternately stacked. As described above, both of the two layers located on the outermost sides of the stacked film 2 are the insulator layers 21 and 21. That is, one semiconductor layer 22 is superposed on one insulator layer 21, and another insulator layer 21 is superposed on the semiconductor layer 22. Alternatively, the semiconductor layers 22 and the insulator layers 21 are alternately superposed, and the insulator layers 21 are finally superposed on the outermost sides. In the above configuration of the stacked film 2, the number of the semiconductor layers 22 is one less than the number of the insulator layers 21.

The total number of stacked films of the insulator layers 21 and the semiconductor layer(s) 22 included in the stacked film 2 is preferably 3 or more and 9 or less. In this case, the capacitance of the capacitor 1 may be further increased. It is particularly preferable that the total number of stacked films of the insulator layers 21 and the semiconductor layer(s) 22 in the stacked film 2 is 3. In other words, it is particularly preferable that the insulator layers 21 include only the first insulator layer 211 and the second insulator layer 212. In this case, the capacitor 1 with increased capacitance can be efficiently produced. When the total number of stacked films of the insulator layers 21 and the semiconductor layer(s) 22 included in the stacked film 2 is 3, the number of the insulator layers 21 is 2 and the number of the semiconductor layers 22 is 1.

### <Insulator Layers>

As described above, the stacked film 2 includes insulator layers 21.

The insulator layers 21 contain a compound of at least one metal selected from the group consisting of aluminum (Al), silicon (Si), tantalum (Ta), and hafnium (Hf), for example. More specifically, the insulator layers 21 contain at least one selected from the group consisting of Al₂O₃, SiO₂, Ta₂O₅, and HfO₂, for example, which are oxides of the above-mentioned metals. In this case, the capacitance of the capacitor 1 may be increased. It is particularly preferable that at least one of the insulator layers 21 contains Al₂O₃. In this case, the capacitance of the capacitor 1 can be significantly increased. Note that only one metal compound may be contained in the one insulator layer 21, or two or more metals may be contained.

Furthermore, it is possible that a metal having an oxide film is produced by oxidizing the surface of a metal that can serve as the anode 3 using an anodization method and a portion of the oxide film is used as the first insulator layer 211. A portion not oxidized by oxidization can be used as the anode 3. The metal having an oxide film obtained using the anodization method may be used as the cathode 4. In this case, the oxide film of the metal having the oxide film may be used as the second insulator layer 212, and the non-oxidized portion may be used as the cathode 4.

Regarding the difference between the thickness of the first insulator layer 211 and the thickness of the second insulator layer 212, the thickness of the first insulator layer 211 is preferably 90% or less of the thickness of the second insulator layer 212. In this case, the capacitance of the capacitor 1 may be further increased. In detail, the capacitance of the capacitor 1 at 100 Hz tends to increase as the film thickness of the first insulator layer 211 decreases. In order to increase the capacitance of the capacitor 1 at 100 Hz by 10% or more, the thickness of the first insulator layer 211 is preferably set to 90% or less of the thickness of the second insulator layer 212. Preferably, the thickness of the first insulator layer 211 is in a specific numerical range of 3.1 nm or more and 18.0 nm or less. In this case, the capacitance of the capacitor 1 may be further increased.

The thickness of each insulator layer 21 can be measured using a transmission electron microscope (TEM). More specifically, the thickness of each insulator layer 21 can be measured in a manner that the thicknesses of 5 or more arbitrarily selected points are measured using a TEM, and the values measured at the 5 or more points are averaged to obtain an average value.

### <Semiconductor Layer>

As described above, the stacked film 2 includes a semiconductor layer 22. As described above, the outermost layers of the stacked film 2 are the insulator layers 21. Therefore, the semiconductor layer 22 is out of contact with the anode 3 and the cathode 4. In other words, the semiconductor layer 22 and the anode 3 or the cathode 4 are not short-circuited. When the number of the semiconductor layers 22 is plural, none of the plurality of semiconductor layers 22 are short-circuited to the anode 3 and the cathode 4.

The semiconductor layer 22 contains a compound of at least one metal selected from the group consisting of zinc (Zn) and titanium (Ti), for example. More specifically, the semiconductor layer 22 contains, for example, at least one selected from the group consisting of ZnO and TiO₂, which are oxides of the above-mentioned metals. In this case, the capacitance of the capacitor 1 may be increased. It is particularly preferable that the semiconductor layer 22 contains ZnO. When the number of the semiconductor layers 22 included in the stacked film 2 is plural, that is, 2 or more, it is particularly preferable that at least one of the plurality of semiconductor layers 22 contains ZnO. In this case, the capacitance of the capacitor 1 may be significantly increased.

The thickness of the semiconductor layer 22 is preferably 2.5 nm or more and 15.0 nm or less. In this case, the capacitance of the capacitor 1 may be increased. More preferably, the thickness of the semiconductor layer 22 is 5.0 nm or more. The thickness of the semiconductor layers 22 is more preferably 10.0 nm or less. The thickness of the semiconductor layer 22 can be measured using the same method as that for the insulator layers 21.

### (1.3) Production Method

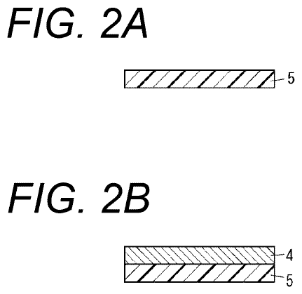

With reference to FIGS. 2A, 2B, 3A to 3D, 4 and 5, a method of producing the capacitor 1 will be described. The following method of producing the capacitor 1 is an example of the method of producing the capacitor 1. That is, as the method of producing the capacitor 1, an appropriate production method can be employed depending on application and purpose of use of the capacitor 1.

The method of producing the capacitor 1 is a method in which the cathode 4, the stacked film 2, and the anode 3 are sequentially produced on a substrate 5 (see FIGS. 2A to 5). In other words, the method of producing the capacitor 1 includes a cathode production step, a stacked film formation step, an anode production step, and an etching step. These steps will be described below in detail.

### <Cathode Production Step>

In the cathode production step, a substrate 5 as illustrated in FIG. 2A is prepared first. For example, a Si substrate is used as the substrate 5. Subsequently, the substrate 5 is washed, for example, with an etchant to remove contaminants such as organic matter adhering to the surface of the substrate 5. As the etchant, buffered hydrofluoric acid (a mixed liquid of hydrofluoric acid and ammonium fluoride) is preferably used.

As illustrated in FIG. 2B, the cathode 4 is then produced on the washed substrate 5. One example of the method of producing the cathode 4 is a method of producing a cathode 4 containing an appropriate metal by continuous film formation using an electron beam vapor deposition method. The electron beam vapor deposition method is a method in which a vapor deposition material is irradiated with an electron beam in a vacuum, heated, and evaporated to deposit the vapor deposition material on the substrate 5, thereby forming a thin film. Examples of the vapor deposition material used to produce the cathode 4 in the present disclosure include Ti, Pt, Al, Ni, TiN, Ta, TaN, and Au.

### <Stacked Film Formation Step>

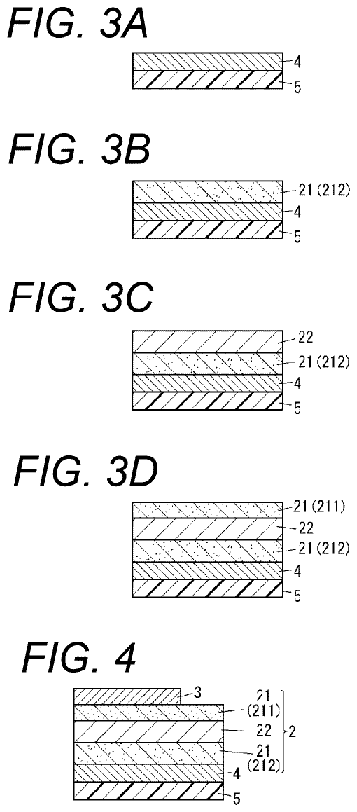

First, a second insulator layer 212 is formed on the cathode 4 (see FIGS. 3A and 3B). Subsequently, a semiconductor layer 22 is formed on the second insulator layer 212 formed on the cathode 4 (see FIG. 3C). Then, a first insulator layer 211 is formed on the semiconductor layer 22 (see FIG. 3D). The stacked film 2 is formed by such a procedure. If necessary, a stacked film 2 in which the total number of stacked films of the insulator layers 21 and the semiconductor layer(s) 22 is 3 or more can be formed by a procedure in which one or more insulator layers 21 and one or more semiconductor layers 22 are alternately formed on the semiconductor layer 22 formed on the second insulator layer 212 and finally a first insulator layer 211 is formed.

One example of the method of producing the insulator layers 21 and the semiconductor layer 22 is a scheme according to an atomic layer deposition method (ALD method). The atomic layer deposition method is a film formation method in which an oxidant and a raw material gas containing a metal are alternately supplied to a reaction chamber in which an object is placed using the atomic layer deposition apparatus (ALD apparatus) to form a layer containing an oxide of the metal on the surface of the object. In the atomic layer deposition method, a self-termination mechanism functions to deposit the metal on the surface of the object in units of atomic layers. Therefore, the thickness of the layer formed can be controlled by adjusting the number of cycles including metal raw material adsorption by raw material gas supply, excess raw material removal by raw material gas exhaust (purge), raw metal material oxidation by oxidant supply, and oxidant exhaust (purge). As the raw material gas, a gasified organometallic compound is preferably used. Further, it is preferable to form the stacked film 2 in a reaction chamber in a reduced pressure atmosphere set prior to film formation. Specifically, the pressure in the reaction chamber is reduced to 26.7 Pa or less, for example.

As to film formation, an inert gas is allowed to flow at a constant flow rate in the reaction chamber during film formation, for example. As the inert gas, N₂ or Ar is used, for example. The flow rate of the inert gas is 4.39×10⁻¹ Pa·m³/s, for example.

The time period for raw material gas supply for metal raw material adsorption is 0.12 seconds or more and 0.14 seconds or less, for example. Excess raw material gas exhaust (purge) is performed by allowing an inert gas to flow. As the inert gas, N₂ or Ar is used. The flow rate of the inert gas in excess raw material gas exhaust (purge) is 4.39×10⁻¹ Pa·m³/s, for example, as described above. The time period for excess raw material gas exhaust (purge) is 10 seconds or more and 20 seconds or less, for example.

The time period for oxidant supply for adsorbed metal raw material oxidization is 0.06 seconds or more and 0.07 seconds or less, for example. As the oxidant, H₂O, O₂ plasma, or O₃ can be used, for example. Among these, H₂O is preferably used. Excess oxidant exhaust is performed by allowing an inert gas to flow. As the inert gas, N₂ or Ar is used. The flow rate of the inert gas in excess oxidant exhaust (purge) can be the same as the flow rate of the inert gas in excess raw material gas exhaust (purge). The time period for excess oxidant exhaust (purge) is 10 seconds or more and 20 seconds or less, for example.

Further, in film formation using the atomic layer deposition method, the temperature for film formation can be 150 °C, for example. This facilitates adjustment of the chemical reaction caused when the insulator layers 21 and the semiconductor layer 22 are formed, thereby achieving stable formation of the insulator layers 21 and the semiconductor layer 22.

The raw material gas used in formation of the insulator layers 21 contains a compound of at least one metal selected from the group consisting of Al, Si, Ta, and Hf, for example. In other words, the raw material gas used in formation of the insulator layers 21 contains at least one selected from the group consisting of an organometallic compound containing Al, an organometallic compound containing Si, an organometallic compound containing Ta, and an organometallic compound containing H, for example.

Examples of the organometallic compound containing Al include, for example, trimethylaluminum (TMA, (CH₃)₃Al). When an organometallic compound containing Al is used, insulator layers 21 containing Al₂O₃ with an adjusted thickness can be formed.

Examples of the organometallic compound containing Si include, for example, tris(dimethylamino) silane (3DMAS, HSi[N(CH₃)₂]₃). When an organometallic compound containing Si is used, insulator layers 21 containing SiO₂ with an adjusted thickness can be formed.

Examples of the organometallic compound containing Ta include, for example (t-butylimido) tris(ethylmethylamino) tantalum (V) (TBTEMT, (CH₃)₃CNTa[N(C₂H₅)CH₃]₃). When an organometallic compound containing Ta is used, insulator layers 21 containing Ta₂O₅ with an adjusted thickness can be formed.

Examples of the organometallic compound containing Hf include, for example, tetrakis(ethylmethylamino) hafnium (TEMAH, Hf[N(C₂H₅)CH₃]₄). When an organometallic compound containing Hf is used, insulator layers 21 containing HfO₂ with an adjusted thickness can be formed.

The raw material gas used in formation of the semiconductor layer 22 contains a compound of at least one metal selected from the group consisting of Zn and Ti, for example. In other words, the raw material gas used in formation of the semiconductor layer 22 contains at least one selected from the group consisting of an organometallic compound containing Zn and an organometallic compound containing Ti, for example.

Examples of the organometallic compound containing Zn include, for example, diethylzinc (DEZ, Zn(C₂H₅)₂). When an organometallic compound containing Zn is used, a semiconductor layer 22 containing a ZnO with an adjusted thickness can be formed.

Examples of the organometallic compound containing Ti include, for example, tetrakis(dimethylamide) titanium (TDMAT, Ti[N(CH₃)₂]₄). When an organometallic compound containing Ti is used, a semiconductor layer 22 containing a TiO₂ with an adjusted thickness can be formed.

### <Anode Production Step>

The anode 3 is produced on the insulator layer 21 located on one of the outermost sides of the stacked film 2, that is, on the first insulator layer 211 (see FIG. 4). For production of the anode 3, a method similar to the method used for producing the cathode 4 can be applied. For example, an anode 3 containing an appropriate metal can be produced using the electron beam evaporation method. Further, the anode 3 can be produced with the same vapor deposition material as used when the cathode 4 is produced. The anode 3 is produced, for example, by partially covering a surface of the first insulator layer 211 located on the side facing the anode 3 (see FIG. 4). As a result, a part of the stacked film 2 that is not sandwiched between the anode 3 and the cathode 4 can be easily removed in a later-described etching step.

### <Etching Step>

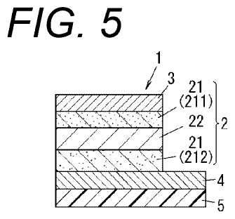

A part of the stacked film 2 that is not sandwiched between the anode 3 and the cathode 4 is removed by etching (see FIG. 5). This can expose a part of the cathode 4, with a result that the exposed part of the cathode 4 can be electrically connected to the ground or the negative electrode of a power supply. While etching is performed using the anode 3 as a mask in the above description, it is possible that the anode 3 and its peripheral part is etched after being protected with a resist or the like in order to protect the anode 3 and the interface between the anode 3 and the first insulator layer 211 from damage during etching.

The capacitor 1 is produced according to the procedure as described above. The procedure for production of the capacitor 1 is not limited to the procedure of sequentially producing the cathode 4, the stacked film 2, and the anode 3 on the substrate 5, as described above. A procedure of sequentially producing the anode 3, the stacked film 2, the cathode 4 on the substrate 5 may be employed.

### (1.4) Performance

The performance of the capacitor 1 will be described.

As described above, the capacitor 1 includes a stacked film 2 of alternately stacked insulator layers 21 and semiconductor layer 22. In the above configuration, the capacitor 1 can have a capacitance higher than a theoretical value C of its series capacitance expressed by the following expression (1).

$$[ Mathematical formula 1 ]$$

$$1 / C = {\sum }_{k = 1}^{n} ( 1 / ( \frac{{ε}_{k} {ε}_{0} S}{{d}_{k}} ) ) \qquad ( 1 )$$

C: Theoretical value of series capacitance
εₖ: Relative permittivity of an insulator layer located at the k-th position from the anode toward the cathode, assuming that the first insulator layer is at the first position.
ε₀: Permittivity of a vacuum
S: Facing area between the anode and the cathode
n: Total number of the insulator layers
dₖ: Thickness of the insulator layer located at the k-th position from the anode toward the cathode, assuming that the first insulator layer is at the first position
εₖ in the above expression (1) represents a relative permittivity of the insulator layer 21 located at k-th position from the anode 3 toward the cathode 4, assuming that the first insulator layer 211 is at the first position. In addition, co represents a permittivity (8.85×10⁻¹² F/m) of a vacuum.

In the above expression (1), S represents the facing area between the anode 3 and the cathode 4. The facing area between the anode 3 and the cathode 4 is the area of a part of the surface of the anode 3 on the side facing the cathode 4 that faces the cathode 4 and also the area of a part of the surface of the cathode 4 on the side facing the anode 3 that faces the anode 3.

In the above expression (1), n represents the total number of the insulator layers 21. As described above, the insulator layers 21 of the stacked film 2 include at least two insulator layers 21. As described above, the total number of semiconductor layers 22 in the stacked film 2 is one smaller than the total number of the insulator layers 21. Therefore, when the total number of the insulator layers 21 is represented by n in the above expression (1), the total number of semiconductor layers 22 is represented by (n-1). In the above expression (1), dx represents the thickness of an insulator layer 21 located at the k-th position from the anode 3 toward the cathode 4, assuming that the first insulator layer 211 is at the first position.

The capacitance of the capacitor 1 tends to increase as the measurement frequency decreases. Specifically, the capacitance of the capacitor 1 tends to increase when the measurement frequency is 1 Mz or less and tends to increase when the measurement frequency is 1000 Hz or less. Furthermore, the capacitance of the capacitor 1 tends to significantly increase when the measurement frequency is 100 Hz, and a capacitance higher than the theoretical value C of a series capacitance expressed by the above expression (1) can be realized especially.

The capacitance of the capacitor 1 of the present disclosure tends to be significantly increased in a certain measurement frequency band. More specifically, as a result of the thickness of the first insulator layer 211 being set smaller than the thickness of the second insulator layer 212 in the capacitor 1, the capacitance tends to be significantly increased in a measurement frequency range of 100 Hz or more and 10,000 Hz or less as compared with a capacitor in which the thickness of the first insulator layer 211 and the thickness of the second insulator layer 212 are the same, or a capacitor in which the thickness of the first insulator layer 211 is larger than the thickness of the second insulator layer 212. As a consequence, the capacitor 1 can be enhanced in performance of removing voltage noise generated in a measurement frequency range of 100 Hz or more and 10,000 Hz or less. In addition, it is further easy to obtain an effect of capacitance increase of the capacitor 1 in a measurement frequency range of 100 Hz or more and 1000 Hz or less. Thus, performance of removing voltage noise generated in a measurement frequency range of 100 Hz or more and 1000 Hz or less can be further enhanced. The capacitance between the anode 3 and the cathode 4 in the capacitor 1 at 100 Hz is preferably 1.1 times or more the theoretical value C of a series capacitance of the insulator layers 21 expressed by the above expression (1), and more preferably 1.5 times or more.

As described above, the capacitance of the capacitor 1 measured at a measurement frequency of 100 Hz tends to be larger than the capacitance of the capacitor 1 measured at a measurement frequency of 1 MHz. Specifically, in the capacitor 1, the capacitance between the anode 3 and the cathode 4 measured at a measurement frequency of 100 Hz may be 1.1 times or more the capacitance between the anode 3 and the cathode 4 measured at a measurement frequency of 1 MHz or may be 1.5 times or more.

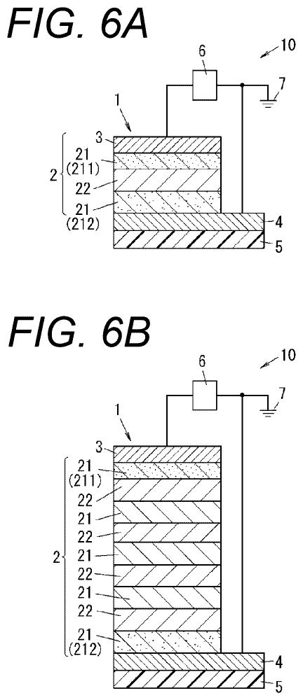

In the capacitor 1, the capacitance between the anode 3 and the cathode 4 in the measurement frequency range from 100 Hz to 1 MHz is a measurement value obtained by using an impedance analyzer 6 (product name: Impedance Analyzer 4294A, vendor: Keysight Technologies). More specifically, the capacitances can be determined from the measurement values obtained when the measurement frequency is set from 100 Hz to 1 MHz in application of an AC voltage of 500 mV between the anode 3 and the cathode 4 in an evaluation circuit 10 fabricated so as to include the capacitor 1 and the impedance analyzer 6 (refer to FIGS. 6A and 6B). The evaluation circuit 10 is fabricated so that the impedance analyzer 6 is connected to the anode 3 and the cathode 4 of the capacitor 1, and the cathode 4 is further connected to a ground 7.

### (2) Variation

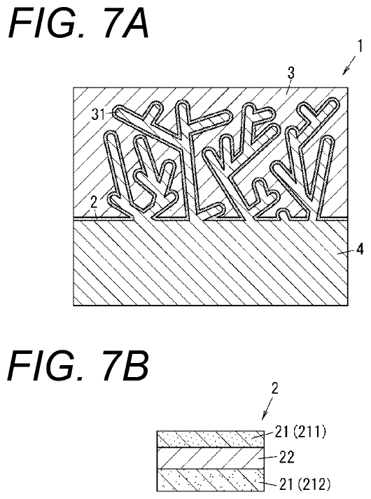

The following describes a variation of the capacitor 1 with reference to FIGS. 7A and 7B. Note that the variation is a variation example in which the configuration of the embodiment is partially changed, added, or deleted, for example. Further, in the variation, the same reference signs are given to the same components as those of the capacitor 1 of the embodiment, and the description thereof is omitted.

In the variation, an anode 3 is a porous body having pores 31, and parts of a cathode 4 penetrate the pores 31 of the anode 3 (see FIG. 7A). A stacked film 2 (see FIG. 7B) is provided between the inner surfaces of the pores 31 and parts of the cathode 4 located in the pores 31. As a result of the cathode 4 penetrating the pores 31, the facing area between the anode 3 and the cathode 4 can be increased. This may increase the capacitance of the capacitor 1. It is also possible to adopt a configuration in which the cathode 4 is a porous body having pores 31, and parts of the anode 3 penetrate the cathode 4.

The capacitance of the capacitor 1 can be increased regardless of the material of the electrode. It is possible in the capacitor 1 that the anode 3 contains aluminum (Al) and the cathode 4 contains a conductive polymer. More specifically, the capacitor 1 includes, in the stated order, an anode 3 containing Al, a stacked film 2 in which insulator layers 21 and a semiconductor layer 22 are alternately stacked, and a cathode 4 containing a conductive polymer, and a first insulator layer 211 in contact with the anode 3 may contain Al₂O₃. In this case, a conductive polymer can be used for the cathode 4 while the capacitance of the capacitor 1 can be increased by using Al, which is a porous body, for the anode 3. Thus, the capacitor 1 can be used as a conductive polymer aluminum electrolytic capacitor. The semiconductor layer 22 included in the stacked film 2 contains ZnO, for example. The stacked film 2 may be a dielectric film located between the anode 3 and the cathode 4 and covering the cathode 4. Even when the anode 3 containing Al is a porous body as described above, the stacked film 2 that has a three-layer structure can be formed using an atomic layer depositing method. Here, the three-layer structure includes a first insulator layer 211 containing Al₂O₃, a semiconductor layer 22 containing ZnO, and a second insulator layer 212 containing Al₂O₃. Further, even when the anode 3 includes an anodic oxide film containing Al₂O₃ on the surface thereof, the stacked film 2 can also be formed by using the anodic oxide film as the first insulator layer 211 and forming two layers of the semiconductor layer 22 containing ZnO and the second insulator layer 212 containing Al₂O₃ thereon using the atomic layer depositing method.

The cathode 4 may contain both a conductive polymer and an electrode containing a metal. Alternatively, the cathode 4 may not contain a conductive polymer. In other words, the capacitor 1 of the variation may have a configuration in which the cathode 4 does not contain a conductive polymer, and a layer containing a conductive polymer is stacked between the second insulator layer 212 and the cathode 4 containing a metal such as silver.

### EXAMPLES

### 1. Capacitor Evaluation (1)

### 1.1 Evaluation Circuit Fabrication Method

Capacitors 1 of Examples 1 to 4 and Comparative Examples 1 and 2 were produced according to the following procedure, and an evaluation circuit 10 including any of the capacitors 1 was fabricated (see FIG. 6A).

First, a substrate 5 (material: Si) was prepared, and washed with buffered hydrofluoric acid. On the washed substrate 5, a cathode 4 (thickness 100 nm) containing Ti was produced using the electron beam deposition method.

Thereafter, the substrate 5 with the cathode 4 stacked thereon was washed with ultrasonic waves while being immersed in an organic solvent such as acetone or isopropyl alcohol.

Subsequently, a second insulator layer 212 containing Al₂O₃ was formed on the cathode 4 using the atomic layer deposition method, which involves sequentially repeating a cycle of supplying trimethylaluminum gas, exhausting the trimethylaluminum gas, supplying H₂O gas, and exhausting the H₂O gas.

Next, a semiconductor layer 22 containing ZnO was formed on the second insulator layer 212 in the same manner as that for forming the second insulator layer 212, except that the trimethylaluminum gas was changed to diethylzinc gas. Thereafter, a first insulator layer 211 containing Al₂O₃ was formed on the semiconductor layer 22 in the same manner as that for forming the second insulator layer 212.

Subsequently, an anode 3 (thickness 100 nm) containing Ti was produced on the first insulator layer 211 using the electron beam deposition method.

Then, a part of the stacked film 2 was removed by etching to expose a part of the cathode 4. Here, the part of the stacked film 2 is a part of the stacked film 2 on the surface side of the cathode 4, which did not face the anode 3. Thus, the capacitors 1 were produced.

With respect to each of the capacitors 1 of Examples 1 to 4 and Comparative Examples 1 and 2, the anode 3 and the exposed part of the cathode 4 were connected to an impedance analyzer 6, and the cathode 4 was connected to a ground 7, thereby fabricating evaluation circuits 10 (see FIG. 6A). As the impedance analyzer 6, Impedance Analyzer 4294A (available at Keysight Technologies) was used.

With respect to each of the capacitors 1 of Examples 1 to 4 and Comparative Examples 1 and 2, the thickness of the first insulator layer 211, the thickness of the second insulator layer 212, and the thickness of the semiconductor layer 22 were adjusted to the numerical values shown in Table 1. Note that, as described above, the insulator layers 21 (the first insulator layer 211 and the second insulator layer 212) and the semiconductor layer 22 were formed using the atomic layer deposition method using the atomic layer deposition device (product name: Fiji F200, vendor: Cambridge Nanotech). The conditions for film formation per cycle in formation of the insulator layers 21 (the first insulator layer 211 and the second insulator layer 212) and the semiconductor layer 22 using the atomic layer deposition method were as follows.

<Insulator layers>
Film formation temperature: 150 °C.
Time to supply raw material gas for metal raw material adsorption: 0.12 seconds
Time to exhaust (purge) excess raw material gas: 10 seconds
Time to supply oxidant for metal raw material oxidization: 0.06 seconds
Time to exhaust (purge) oxidant for oxidant removal: 10 seconds
   <Semiconductor layer>
Film formation temperature: 150 °C.
Time to supply raw material gas for metal raw material adsorption: 0.14 seconds
Time to exhaust (purge) excess raw material gas: 20 seconds
Time to supply oxidant for metal raw material oxidization: 0.07 seconds
Time to exhaust (purge) oxidant for oxidant removal: 20 seconds

In the film formation, Ar was used as an inert gas, and the inert gas was allowed to flow at a constant flow rate. The flow rate of the inert gas was set to 4.39×10⁻¹ Pa·m³/s. That is, the oxidant exhaust (purge) for metal raw material oxidization and the oxidant exhaust (purge) for oxidant removal were performed at the above flow rate. The number of cycles performed during the film formation using the atomic layer deposition method was adjusted so that the thickness of the first insulator layer 211, the thickness of the second insulator layer 212, and the thickness of the semiconductor layer 22 were set to the values shown in Table 1.

### 1.2 Evaluation Results

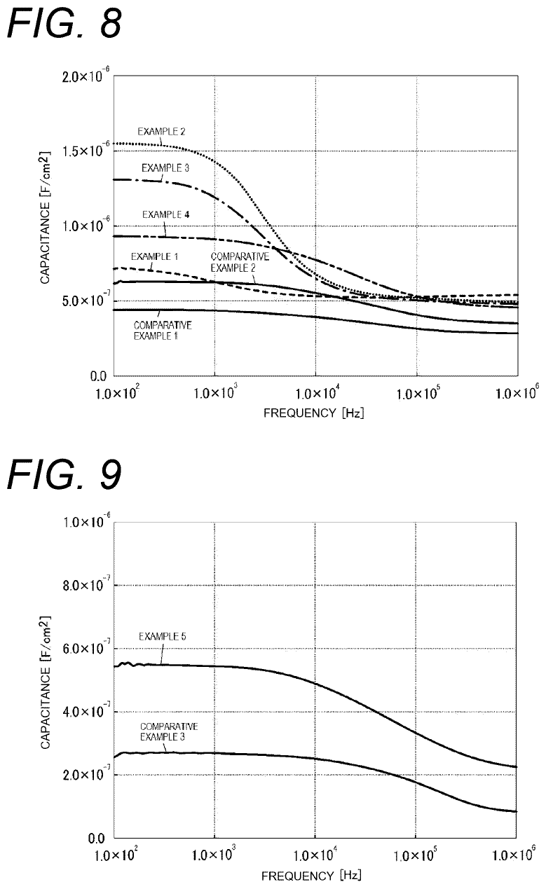

With respect to the evaluation circuits 10 including the respective capacitors 1 of Examples 1 to 4 and Comparative Examples 1 and 2, the capacitance of each of the capacitors 1 of Examples 1 to 4 and Comparative Examples 1 to 2 was measured by applying an AC voltage of 500 mV in a frequency band from 100 Hz to 1 MHz between the anode 3 and the cathode 4. The relationships between the measurement frequency and the capacitance in the respective capacitors 1 of Examples 1 to 4 and Comparative Examples 1 and 2 are shown in FIG. 8. Table 1 shows the measurement results of the capacitances obtained when the measurement frequency was set to 100 Hz and 1 MHz. The theoretical values of series capacitances of the capacitors 1 of Examples 1 to 4 and Comparative Examples 1 and 2 indicated in Table 1 were values calculated according to expression (1) described in “(1.4) Performance”.

TABLE 1

| | Stacked film | | | | | | |
|---|---|---|---|---|---|---|---|
| | | Insulator | | | Evaluation result | | |
| | Number | layer | | | Capacitance | | |
| | of | thickness | | Semi- | | | Theoretical |
| | layers | First | Second | conductor | | | value |
| | of | insulator | insulator | layer | Capacitance | Capacitance | of series |
| | stacked | layer | layer | thickness | @ 100 Hz | @ 1 MHz | capacitance |
| | film | nm | nm | nm | F/cm² | F/cm² | F/cm² |
| Example 1 | 3 | 2.5 | 8.3 | 5.1 | 7.4 × 10⁻⁷ | 5.4 × 10⁻⁷ | 5.8 × 10⁻⁷ |
| Example 2 | 3 | 3.1 | 8.3 | 5.1 | 1.6 × 10⁻⁶ | 4.9 × 10⁻⁷ | 5.5 × 10⁻⁷ |
| Example 3 | 3 | 3.9 | 8.3 | 5.1 | 1.3 × 10⁻⁶ | 4.8 × 10⁻⁷ | 5.1 × 10⁻⁷ |
| Example 4 | 3 | 6.1 | 8.3 | 5.1 | 9.4 × 10⁻⁷ | 4.5 × 10⁻⁷ | 4.3 × 10⁻⁷ |
| Comparative | 3 | 12.7 | 8.3 | 5.1 | 4.5 × 10⁻⁷ | 2.8 × 10⁻⁷ | 3.0 × 10⁻⁷ |
| Example 1 | | | | | | | |
| Comparative | 3 | 8.3 | 8.3 | 5.1 | 6.4 × 10⁻⁷ | 3.5 × 10⁻⁷ | 3.7 × 10⁻⁷ |
| Example 2 | | | | | | | |

It was demonstrated that in each of the capacitors 1 of Examples 1 to 4 in which the thickness of the first insulator layer 211 was smaller than the thickness of the second insulator layer 212, the capacitance was increased regardless of the measurement frequency as compared with the capacitor 1 of Comparative Example 1 in which the thickness of the first insulator layer 211 was larger than the thickness of the second insulator layer 212, and the capacitor 1 of Comparative Example 2 in which the thickness of the first insulator layer 211 was the same as the thickness of the second insulator layer 212.

According to the evaluation results of Examples 2 to 4 and Comparative Examples 1 and 2, the capacitance measured at a measurement frequency of 100 Hz tends to increase as the film thickness of the first insulator layer 211 decreases. That is, the capacitance of the capacitor 1 measured at a measurement frequency of 100 Hz can be controlled according to the film thickness of the first insulator layer 211.

By contrast, the capacitance of Example 1 measured at a measurement frequency of 100 Hz was found to be increased relative to that of Comparative Example 2 but found to be decreased relative to that of Example 2. In areas of the first insulator layer 211 where the thickness was smaller than 2.5 nm, the direct tunneling current became unignorably large even though it was an insulator. The anode 3 and the semiconductor layer 22 were electrically integrated, with a result that the characteristics of the second insulator layer 212 were reflected in the evaluation of the capacitor 1. In order to efficiently realize a capacitance increase, the thickness of the first insulator layer 211 is preferably 3.1 nm or more.

With respect to each of Examples 1 to 4, comparison between the capacitance measured at a measurement frequency of 100 Hz and the capacitance measured at a measurement frequency of 1 MHz indicated that the capacitance of the capacitor 1 measured at a measurement frequency of 100 Hz was more different from the theoretical value of its series capacitance than the capacitance of the capacitor 1 measured at a measurement frequency of 1 MHz.

With respect to each of Examples 1 to 4, comparison between the capacitance measured at a measurement frequency of 100 Hz and the capacitance measured at a measurement frequency of 1 MHz indicated that the capacitance of the capacitor 1 measured at a measurement frequency of 100 Hz was further increased by appropriately adjusting the difference between the thickness of the first insulator layer 211 and the thickness of the second insulator layer 212 of the capacitor 1.

### 2. Capacitor Evaluation (2)

### 2.1 Evaluation Circuit Fabrication Method

According to the procedure described in “1. Capacitor Evaluation, 1.1 Evaluation Circuit Fabrication Method”, capacitors 1 of Example 5 and Comparative Example 3 were produced that each included an anode 3 containing Ti (thickness 100 nm), a stacked film 2, and a cathode 4 containing Ti (thickness 100 nm). Thereafter, evaluation circuits 10 including the respective capacitors 1 (see FIG. 6A) were fabricated.

The stacked film 2 had a three-layer structure consisting of a first insulator layer 211 containing Al₂O₃, a semiconductor layer 22 containing ZnO, and a second insulator layer 212 containing Al₂O₃. Each of the insulator layers 21 was formed by the same manner as the manner for forming the insulator layers 21 described in “1. Capacitor Evaluation, 1.1 Evaluation Circuit Fabrication Method”. The semiconductor layer 22 was also formed by the same manner as the manner for forming the semiconductor layer 22 described in “1. Capacitor Evaluation, 1.1 Evaluation Circuit Fabrication Method”.

The thicknesses of the insulator layers 21 (the thickness of the first insulator layer 211 and the thickness of the second insulator layer 212) and the thickness of the semiconductor layer 22 were adjusted to the numerical values shown in Table 2. The number of cycles in the film formation using the atomic layer deposition method was adjusted so that the thickness of the first insulator layer 211, the thickness of the second insulator layer 212, and the thickness of the semiconductor layer 22 were set to the values shown in Table 2.

### 2.2 Evaluation Results

With respect to the evaluation circuits 10 including the respective capacitors 1 of Example 5 and Comparative Example 3, the capacitances of the capacitors 1 of Example 5 and Comparative Example 3 were evaluated by applying an AC voltage of 500 mV in a frequency band from 100 Hz to 1 MHz between the anode 3 and the cathode 4. FIG. 9 shows the relationships between the measurement frequency and the capacitances of the capacitors 1 of Example 5 and Comparative Example 3. Table 2 shows the measurement results of the capacitances measured at a measurement frequency of 100 Hz and a measurement frequency of 1 MHz. The theoretical values of series capacitances of Example 5 and Comparative Example 3 were calculated according to expression (1) described in “(1.4) Performance”.

TABLE 2

| | Stacked film | | | | | | |
|---|---|---|---|---|---|---|---|
| | | Insulator | | | Evaluation result | | |
| | Number | layer | | | Capacitance | | |
| | of | thickness | | Semi- | | | Theoretical |
| | layers | First | Second | conductor | | | value |
| | of | insulator | insulator | layer | Capacitance | Capacitance | of series |
| | stacked | layer | layer | thickness | @ 100 Hz | @ 1 MHz | capacitance |
| | film | nm | nm | nm | F/cm² | F/cm² | F/cm² |
| Example 5 | 3 | 10.0 | 20.5 | 5.1 | 5.6 × 10⁻⁷ | 2.3 × 10⁻⁷ | 2.0 × 10⁻⁷ |
| Comparative | 3 | 20.5 | 20.5 | 5.1 | 2.7 × 10⁻⁷ | 8.3 × 10⁻⁸ | 1.5 × 10⁻⁷ |
| Example 3 | | | | | | | |

The first insulator layers 211 of the capacitors 1 of Example 5 and Comparative Example 3 were larger than those of the capacitors 1 of Examples 1 to 4 and Comparative Examples 1 and 2. It was demonstrated that as a result of the thickness of the first insulator layer 211 being set smaller than the thickness of the second insulator layer 212 in Example 5, the capacitance measured at a measurement frequency of 100 Hz was higher in the capacitor 1 of Example 5 than in the capacitor 1 of Comparative Example 3.

The first insulator layers 211 of the capacitors 1 of Example 5 and Comparative Example 3 were thicker than those of the capacitors 1 of Examples 1 to 4 and Comparative Examples 1 and 2. It was demonstrated that the capacitance of the capacitor 1 of Example 5 measured at a measurement frequency of 100 Hz was larger than the theoretical value of their series capacitances, compared to the capacitor 1 of Comparative Example 3.

### 3. Capacitor Evaluation (3)

### 3.1 Evaluation Circuit Fabrication Method

According to the procedure described in “1. Capacitor Evaluation, 1.1 Evaluation Circuit Fabrication Method”, capacitors 1 of Example 5 and Comparative Example 3 were produced that each included an anode 3 containing Ti (thickness 100 nm), a stacked film 2, and a cathode 4 containing Ti (thickness 100 nm), and evaluation circuits 10 including the respective capacitors 1 (see FIG. 6B) were fabricated.

The stacked film 2 had a nine-layer structure in which insulator layers 21 containing Al₂O₃ and semiconductor layers 22 containing ZnO were alternately stacked. Each of the insulator layers 21 was formed by the same manner as that for forming the insulator layers 21 described in “1. Capacitor Evaluation, 1.1 Evaluation Circuit Fabrication Method”, and each of the semiconductor layers 22 was also formed by the same manner as that for forming the semiconductor layer 22 described in “1. Capacitor Evaluation, 1.1 Evaluation Circuit Fabrication Method”.

The thicknesses of the insulator layers 21 (the thickness 211 of the first insulator layer and the thicknesses of the insulator layers 21 other than the first insulator layer 211) and the thickness of the semiconductor layers 22 were adjusted to the numerical values shown in Table 3. In the capacitors 1 of Example 6 and Comparative Example 4, the thicknesses of the insulator layers 21 other than the first insulator layer 211 were all the same, and the thicknesses of the semiconductor layers 22 were all the same. Further, the number of the cycles in the film formation using the atomic layer deposition method was adjusted so that the thickness of the first insulator layer 211, the thicknesses of the insulator layers 21 other than the first insulator layer 211, and the thicknesses of the semiconductor layers 22 were set to the values shown in Table 3.

### 3.2 Evaluation Results

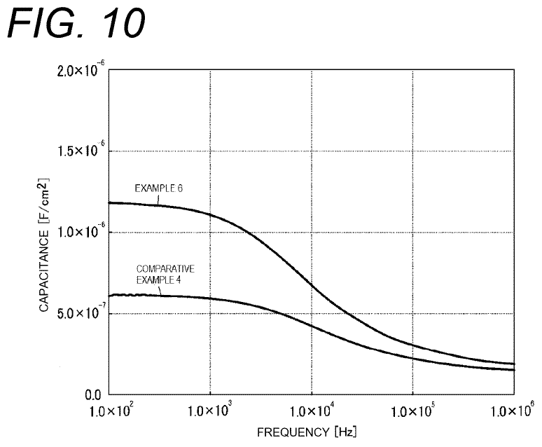

Using the evaluation circuits 10 including the respective capacitors 1 of Example 6 and Comparative Example 4, the capacitances of the capacitors 1 of Example 6 and Comparative Example 4 were evaluated by applying an AC voltage of 500 mV in a frequency band from 100 Hz to 1 MHz between the anode 3 and the cathode 4. FIG. 10 shows the relationships between the measurement frequency and the capacitances of the capacitors 1 of Example 6 and Comparative Example 4. Table 3 shows the measurement results of the capacitances measured at a measurement frequency of 100 Hz and a measurement frequency of 1 MHz. The theoretical values of series capacitances of Example 6 and Comparative Example 4 were calculated according to expression (1) described in “(1.4) Performance”.

TABLE 3

| | Stacked film | | | | | | |
|---|---|---|---|---|---|---|---|
| | | Insulator layer | | | | | |
| | | thickness | | | | | |
| | | | Insulator | | Evaluation result | | |
| | Number | | layers | | Capacitance | | |
| | of | | other | Semi- | | | Theoretical |
| | layers | First | than first | conductor | | | value |
| | of | insulator | insulator | layer | Capacitance | Capacitance | of series |
| | stacked | layer | layer | thickness | @ 100 Hz | @ 1 MHz | capacitance |
| | film | nm | nm | nm | F/cm² | F/cm² | F/cm² |
| Example 6 | 9 | 3.9 | 8.3 | 5.1 | 1.2 × 10⁻⁶ | 1.9 × 10⁻⁷ | 1.7 × 10⁻⁷ |
| Comparative | 9 | 8.3 | 8.3 | 5.1 | 6.2 × 10⁻⁷ | 1.6 × 10⁻⁷ | 1.5 × 10⁻⁷ |
| Example 4 | | | | | | | |

In the capacitors 1 of Example 6 and Comparative Example 4, the number of layers of the stacked film 2 was larger than those in the capacitors 1 of Examples 1 to 4 and Comparative Examples 1 and 2. It was demonstrated that the capacitor 1 of Example 6 had a higher capacitance measured at a measurement frequency of 100 Hz than the capacitor 1 of Comparative Example 4 as a result of the thickness of the first insulator layer 211 being set smaller than the thickness of the second insulator layer 212.

Further, the number of layers of the stacked film 2 was larger in the capacitors 1 of Example 6 and Comparative Example 4 than in the capacitors 1 of Examples 1 to 4 and Comparative Examples 1 and 2. It was demonstrated that when the measurement frequency was 100 Hz, the difference between the capacitance of the capacitor 1 of Example 6 and the theoretical value of its series capacitance was larger than the difference between the capacitance of the capacitor 1 of Comparative Example 4 and the theoretical value of its series capacitance.

### (3) Overview

As is apparent from the embodiment described above, the capacitor (1) according to a first aspect of the present disclosure includes an anode (3), a stacked film (2), and a cathode (4) that are stacked in a stated order. The stacked film (2) includes at least two insulator layers (21) and at least one semiconductor layer (22). The insulator layers (21) and the semiconductor layer (22) are alternately stacked. The insulator layers (21) include a first insulator layer (211) in contact with the anode (3), and a second insulator layer (212) in contact with the cathode (4). The thickness of the first insulator layer (211) is smaller than the thickness of the second insulator layer (212).

According to the first aspect, the capacitor (1) which includes the stacked film (2) in which the insulator layers (21) and the semiconductor layer (22) are stacked can be provided with increased capacitance.

In a capacitor (1) according to a second aspect of the present disclosure, at least one of the insulator layers (21) contains Al₂O₃ in the first aspect.

According to the second aspect, the capacitance of the capacitor (1) can be significantly increased.

In a capacitor (1) according to a third aspect of the present disclosure, the thickness of the first insulator layer (211) is 3.1 nm or more and 18.0 nm or less in the first or second aspect.

According to the third aspect, the capacitance of the capacitor (1) can be further increased.

In a capacitor (1) of a fourth aspect of the present disclosure, the insulator layers (21) include only the first insulator layer (211) and the second insulator layer (212) in any one of the first to third aspects.

According to the fourth aspect, the capacitor (1) with increased capacitance can be efficiently produced.

In a capacitor (1) according to a fifth aspect of the present disclosure, a capacitance between the anode (3) and the cathode (4) at a measurement frequency of 100 Hz is larger than a theoretical value of a series capacitance of the insulator layers (21) expressed by the following expression (1) in any one of the first to fourth aspects.

$$[ Mathematical formula 2 ]$$

$$1 / C = {\sum }_{k = 1}^{n} ( 1 / ( \frac{{ε}_{k} {ε}_{0} S}{{d}_{k}} ) ) \qquad ( 1 )$$

C: Theoretical value of series capacitance
εₖ: Relative permittivity of an insulator layer of the insulator layers located at a k-th position from the anode toward the cathode, assuming that the first insulator layer is at the first position.
ε₀: Permittivity of a vacuum
S: Facing area between the anode and the cathode
n: Number of the insulator layers
dₖ: Thickness of the insulator layer located at the k-th position from the anode toward the cathode, assuming that the first insulator layer is at the first position

According to the fifth aspect, the capacitance of the capacitor (1) measured at a measurement frequency of 100 Hz can be significantly increased.

In a capacitor (1) according to a sixth aspect of the present disclosure, the semiconductor layer (22) contains ZnO in any one of the first to fifth aspects.

According to the sixth aspect, the capacitance of the capacitor (1) can be significantly increased.

In a capacitor (1) according to a seventh aspect of the present disclosure, at least one of the anode (3) and the cathode (4) contains at least one of Ti, Pt, and Al in any one of the first to sixth aspects.

According to the seventh aspect, the capacitance of the capacitor (1) can be increased.

In a capacitor (1) according to an eighth aspect of the present disclosure, the anode (3) contains Al, and the cathode (4) contains a conductive polymer in any one of the first to seventh aspects.

According to the eighth aspect, the capacitor (1) is applicable to a conductive polymer aluminum electrolytic capacitor.

### REFERENCE SIGNS LIST

1 Capacitor
2 Stacked film
3 Anode
4 Cathode
21 Insulator layer
22 Semiconductor layer
211 First insulator layer
212 Second insulator layer

1. A capacitor comprising:
an anode, a stacked film, and a cathode that are stacked in a stated order, wherein
the stacked film includes at least two insulator layers and at least one semiconductor layer, the insulator layers and the semiconductor layer being alternately stacked,
the insulator layers include a first insulator layer in contact with the anode, and a second insulator layer in contact with the cathode, and
a thickness of the first insulator layer is smaller than a thickness of the second insulator layer.

2. The capacitor according to claim 1, wherein
at least one of the insulator layers contains Al₂O₃.

3. The capacitor according to claim 1, wherein
a thickness of the first insulator layer is 3.1 nm or more and 18.0 nm or less,

4. The capacitor according to claim 1, wherein
the insulator layers include only the first insulator layer and the second insulator layer.

5. The capacitor according to claim 1, wherein
a capacitance between the anode and the cathode measured at a measurement frequency of 100 Hz is larger than a theoretical value of a series capacitance of the insulator layers expressed by following expression (1):
$$[ Mathematical formula 1 ]$$
$$1 / C = {\sum }_{k = 1}^{n} ( 1 / ( \frac{{ε}_{k} {ε}_{0} S}{{d}_{k}} ) ) \qquad ( 1 )$$
where C represents the theoretical value of the series capacitance, εₖ represents a relative permittivity of an insulator layer of the insulator layers located at a k-th position from the anode toward the cathode, assuming that the first insulator layer is at a first position,
ε₀ represents a permittivity of a vacuum,
S represents a facing area between the anode and the cathode,
n represents the number of the insulator layers, and
dₖ represents a thickness of the insulator layer located at the k-th position from the anode toward the cathode, assuming that the first insulator layer is at the first position.

6. The capacitor according to claim 1, wherein
the semiconductor layer contains ZnO.

7. The capacitor according to claim 1, wherein
at least one of the anode and the cathode contains at least one of Ti, Pt, and Al,

8. The capacitor according to claim 1, wherein
the anode contains Al, and the cathode contains a conductive polymer.
